(19) United States
(12) Patent Application Publication
(10) Pub. No.: US 2024/0411985 A1
(43) Pub. Date: Dec. 12, 2024

(54) INFORMATION PROCESSING METHOD AND APPARATUS, AND TERMINAL AND STORAGE MEDIUM

(71) Applicant: Beijing Zitiao Network Technology Co., Ltd., Beijing (CN)

(72) Inventors: Zhifeng LIN, Beijing (CN); Hangyu DONG, Beijing (CN); Zebin CHEN, Beijing (CN); Wanjun HUANG, Beijing (CN)

(21) Appl. No.: 18/811,609

(22) Filed: Aug. 21, 2024

Related U.S. Application Data
(63) Continuation of application No. PCT/CN2023/077640, filed on Feb. 22, 2023.

(30) Foreign Application Priority Data
Feb. 22, 2022 (CN) 202210161533.2

(51) Int. Cl. G06F 40/186

(52) U.S. Cl. CPC G06F 40/186

(57) ABSTRACT

Provided in the present disclosure are an information processing method and apparatus, and a terminal and a storage medium. The information processing method provided in an embodiment of the present disclosure comprises: displaying a first document; and in response to a first operation event on a first document, adding a document template attribute to the first document, and displaying a first control in an associated region of the first document or in an associated region of a content page of the first document, wherein the first control is used for creating a document by using the first document as a template after the first control is triggered.

### CROSS-REFERENCE TO RELATED APPLICATIONS

This application is a continuation of International Application No. PCT/CN2023/077640, as filed on Feb. 22, 2023, which is based on and claims priority to CN patent application No. 202210161533.2 titled “INFORMATION PROCESSING METHOD AND APPARATUS, AND TERMINAL AND STORAGE MEDIUM” and filed on Feb. 22, 2022, the disclosure of each of these applications is incorporated by reference herein in its entirety.

### TECHNICAL FIELD

The present disclosure relates to the field of computer technology, in particular to an information processing method and apparatus, a terminal and a storage medium.

### BACKGROUND

During a document processing process, it is often necessary to use a template; the user creates a document based on a template, and a template and a document are usually different types of files.

### SUMMARY

The present disclosure provides an information processing method and apparatus, a terminal and a storage medium.

The present disclosure uses the following technical solution.

In some embodiments, the present disclosure provides an information processing method, the method comprising:
displaying a first document; and
adding a document template attribute to the first document in response to a first operation event on the first document, and displaying a first control in an associated area of the first document or an associated area of a content page of the first document, wherein the first control is used for creating a document by using the first document as a template after the first control is triggered.

In some embodiments, the present disclosure provides an information processing apparatus, the apparatus comprising:
a display unit for displaying a first document; and
a control unit for adding a document template attribute to the first document in response to a first operation event on the first document, and displaying a first control in an associated area of the first document or an associated area of a content page of the first document, wherein the first control is used for creating a document by using the first document as a template after the first control is triggered.

In some embodiments, the present disclosure provides a terminal, the terminal comprising: at least one memory and at least one processor;
wherein the at least one memory is configured to store program codes, and the at least one processor is configured to call the program codes stored in the at least one memory to perform the above-described method.

In some embodiments, the present disclosure provides a non-transient computer-readable storage medium for storing program codes that, when executed by a processor, causes the processor to perform the method according to any of the present disclosure.

The information processing method provided in an embodiment of the present disclosure comprises: displaying a first document; adding a document template attribute to the first document in response to a first operation event on the first document, and displaying a first control in an associated region of the first document or in an associated region of a content page of the first document, wherein the first control is used for creating a document by using the first document as a template after the first control is triggered.

### BRIEF DESCRIPTION OF THE ACCOMPANYING DRAWINGS

The above-described and other features, advantages and aspects of embodiments of the present disclosure will become more apparent in conjunction with the accompanying drawings and with reference to the following detailed description. Throughout the accompanying drawings, the same or similar reference numerals indicate the same or similar elements. It should be understood that the accompanying drawings are schematic and that components and elements are not necessarily drawn to scale.

FIG. 1 is a flowchart of an information processing method according to an embodiment of the present disclosure.

FIG. 2 is a schematic display view when a first document does not have a document template attribute according to an embodiment of the present disclosure.

FIG. 3 is a schematic display view of a first document according to an embodiment of the present disclosure.

FIG. 4 is a schematic display view wherein a first document has a document template attribute according to an embodiment of the present disclosure.

FIG. 5 is a schematic view of a display interface of a document application according to an embodiment of the present disclosure.

FIG. 6 is a schematic view of a display interface of a communication application according to an embodiment of the present disclosure.

FIG. 7 is a schematic view of a sharing process of a first document according to an embodiment of the present disclosure.

FIG. 8 is a schematic view of a sharing process of a first document according to an embodiment of the present disclosure.

FIG. 9 is a schematic view of a first document shared in a session according to an embodiment of the present disclosure.

FIG. 10 is a schematic structural view of an electronic device according to an embodiment of the present disclosure.

### DETAILED DESCRIPTION

The embodiments of the present disclosure will be described in more detail with reference to the accompanying drawings below. Although the accompanying drawings illustrate some embodiments of the present disclosure, it should be understood that the present disclosure may be implemented in various forms, and should not be construed as being limited to the embodiments set forth herein; rather, these embodiments are provided for a more thorough and complete understanding of the present disclosure. It should be understood that the accompanying drawings and embodiments of the present disclosure are only for illustrative purposes, rather than for limiting the protection scope of the present disclosure.

It should be understood that the various steps recited in the method embodiments of the present disclosure may be performed according to a sequence, and/or performed in parallel. In addition, the method embodiments may comprise additional steps and/or omit to perform the illustrated steps. The scope of the present disclosure is not limited in this respect.

As used herein, the term “comprising” and its variants are open-ended inclusion, that is, “comprising but not limited to”. The term “based on” means “at least partially based on”. The term “one embodiment” means “at least one embodiment”; the term “another embodiment” means “at least one additional embodiment”; and the term “some embodiments” means “at least some embodiments”. The related definitions of other terms will be given in the following description.

It should be noted that the concepts such as “first” and “second” mentioned in the present disclosure are only used to distinguish different devices, modules or units, but not to limit the order or interdependence of functions performed by these devices, modules or units.

It should be noted that the modifications of “one” mentioned in the present disclosure are illustrative rather than restrictive, and those skilled in the art should understand that they should be understood as “one or more” unless contextually specified otherwise.

The names of messages or information exchanged between multiple devices in the embodiments of the present disclosure are only used for illustrative purposes, but not for limiting the scope of these messages or information.

The solution provided by the embodiment of the application will be described in detail below in conjunction with the accompanying drawings.

A document, such as an online document, usually provides the function of storing a document as a document template; after a document is stored as a document template, the user may select a document template in a template library and create a new document based on the document template; since the use path of a document template is independent of a document, the user needs to additionally memorize a storage path, which results in inconvenient use; in order to avoid this problem, some users name a document as a template and copy the document every time for use, which results in inconvenient management, and the document cannot be found in the template library and cannot be used in a scene where a template is used. With the above-described problems, the user experience is insufficient.

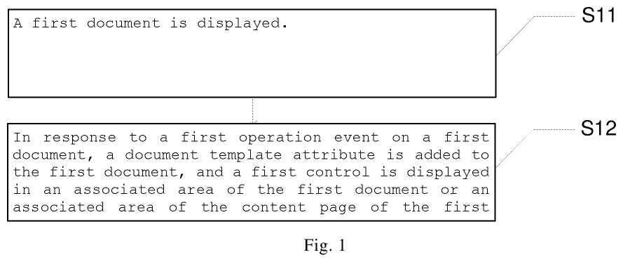

In some embodiments of the present application, an information processing method is provided, which may be used for document processing, for example, online document processing; in some embodiments, as shown in FIG. 1, which is a flowchart of an information processing method according to an embodiment of the present disclosure, the method comprises the following steps.

In S11, a first document is displayed.

In some embodiments, the information processing method may be used in a terminal or a server, so that the first document may be displayed on a browser or a client. In some embodiments, the displaying a first document may be displaying a content page of the first document after the first document is opened, or displaying a first document in a document list of a document database when the first document is not opened.

In S12, in response to a first operation event on a first document, a document template attribute is added to the first document, and a first control is displayed in an associated area of the first document or an associated area of the content page of the first document.

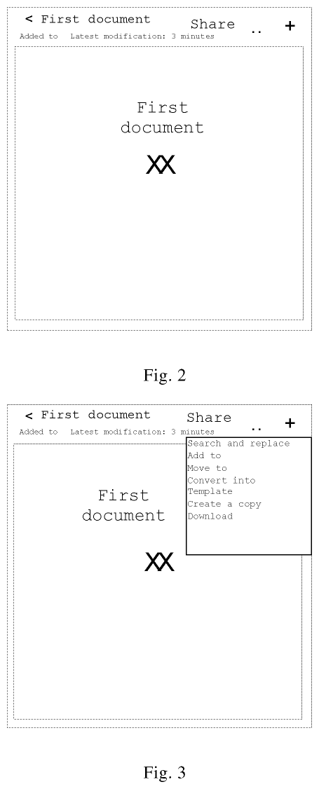

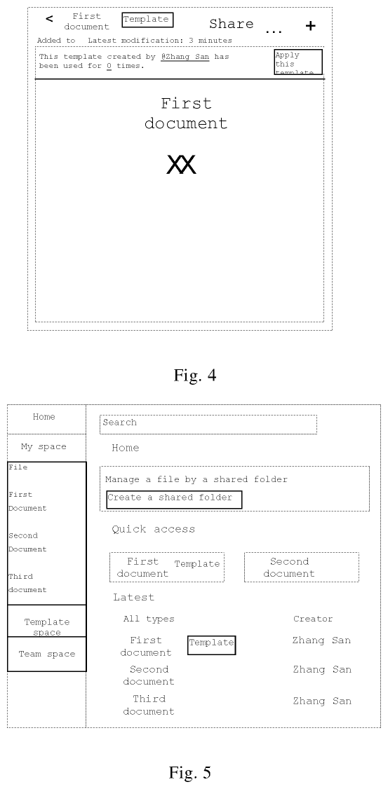

In some embodiments, as shown in FIG. 2, the first document is opened in step S11, wherein the first document may be an online document, may have an associated tool or control and the like, and the first operation event may comprise one or more operations, for example, a trigger operation on a document or control associated with the first document; in some embodiments, in response to a first operation event on a first document, a document template attribute may be added to the first document, so that the first document has both a document attribute and a document template attribute. The document template attribute may identify the first document as a document template, and the document attribute may identify the first document as a document; that is, in some embodiments of the present disclosure, the first document is both a document and a document template, so that the first document may be obtained when documents of a document type are searched, and the first document may also be obtained when documents of a document template type are searched; since the first document serves as both a document and a document template, it has both a function of a document and a function of a document template; in some embodiments, an associated area of the first document may be, for example, a peripheral side of a title of the first document, and in this case, the first document may not be opened and the first control may be displayed on a peripheral side of a title of the first document that is not opened, and an associated area of the content area of the first document may be, for example, the top or left or right areas of the content area after the first document is opened; in some embodiments, as shown in FIG. 4, in response to a first operation event, the button “Apply this template” as the first control is displayed on the right upper side of the first document, and the first control can be triggered, for example, by clicking, so that a new document will be created by using the first document as a template. The user may directly operate the first control to create a new document without searching for a template in a template library, and the user does not need to additionally memorize an operation path during use, so as to reduce the memory cost, and an operation on a document is still applicable to the first document.

In some embodiments, it is possible to display the first document in the document list of the document database, receive the first operation event on the first document, and add the document template attribute to the first document without opening the first document.

In some embodiments of the present disclosure, a document template and a document are unified, and the document template is used as a special document; in this way, the separation of functions of the document template from functions of the document is avoided, and the document template has all the functions of the document, thereby avoiding repeated development of the same functions of the document template and the document, better conforming to use habits of a user, and reducing a memorization burden on the user.

In some embodiments of the present disclosure, the adding a document template attribute to the first document in response to a first operation event on the first document comprises: adding a document template attribute to the first document in response to a second control associated with the first document shifting from a first state to a second state, wherein the second control has a first state and a second state, when the second control is in the first state, the first document has a document attribute, and when the second control is in the second state, the first document has a document attribute and a document template attribute. In some embodiments, when the first document is in an open state, a toolbar may be displayed; the toolbar has a second control or a second control is displayed after an option in the toolbar is triggered, for example, a control list shown in FIG. 3 is displayed after the “ . . . ” in FIG. 2 is triggered, and the control list displays a second control, which may be a switch; the switch corresponding to “Convert to template” in FIG. 3 is a second control, and the switch has two states, wherein the first document is a document in a first state of the switch, and the first document is both a document and a document template in a second state of the switch. In this embodiment, since the attribute of the first document is determined by changing a state of the second control and the first document itself always has a document attribute, the user paths of a document template and a document are integrated without an “saved as” operation on the first document, and the first document is still stored in its original location without prompting the user to choose a saving location when a document template attribute is provided to the first document, and the document template attribute of the first document may be removed by changing a state of the second control, so that it is convenient for the user to shift a state of the first document with one button for convenient use.

In some embodiments of the present disclosure, the method further comprises: adding a template tag to the first document, wherein the template tag is used for identifying the first document as a document template. In some embodiments, by adding a template tag to the first document, the first document is distinguished from other documents that are not document templates, thereby ensuring that the first document is distinguished from an ordinary document in various scenes of circulated use so as to facilitate rapid identification. In some embodiments, a template tag is displayed in an associated area of the title of the first document, wherein the template tag is used for identifying the first document as a document template. In some embodiments, referring to FIG. 4, after the first operation event is performed on the first document, that is, when the first document has a document template attribute, the wording “Template” is displayed next to the title of the first document as a template tag, so that the user may confirm a state of the first document by the template tag. In some embodiments of the present disclosure, the first document is only provided with a template tag, and its use path and management methods are the same as a document that is not a document template, so that the first document may be managed in the same way as an ordinary document for convenient use by the user.

In some embodiments of the present disclosure, the method further comprises: displaying a second document created by using the first document as a template in response to a second operation event on the first document. In some embodiments, the template tag may be triggered, for example, by clicking, and the second document created by using the first document as a template will be displayed at this time; in some embodiments, considering permission for a user, only the documents created by using the first document as a template for which a current user has a viewing permission will be displayed. In this embodiment, a document created by using the first document as a template may be viewed quickly.

In some embodiments of the present disclosure, the content in the first document is modified in response to a first modification operation, and the modified content of the first document is applied to a second document in response to a third operation event on the first document. In some embodiments, the user may modify the content of the first document, for example, modifying a typeface of the title, a typeface of the text, and modifying a specific text description; in this case, the template tag may be triggered by, for example, long press or other methods, so that the modified content may be applied to all the second documents created by using the first document as a template without modifying each document one by one; in some embodiments, considering permission for the user, the modified content of the first document is applied to only the documents created by using the first document as a template for which a current user has an editing permission.

In some embodiments of the present disclosure, the method further comprises: displaying a first document in a document classification of a document database and displaying a first document in a document template classification. In some embodiments, a document may be displayed in a document database for storing documents, wherein the document database may be a cloud; in this embodiment, the first document may be displayed both in a document classification and a document template classification, and the user may find the first document when searching for a document, and may also find the first document when searching for a document template. In some related arts, a document is distinguished from a document template, so that a document template cannot be obtained by searching a document classification, but can only be obtained by searching a document template classification; in this way, the user needs to memorize two storage paths, so that it is inconvenient for use by the user, and the operations that can be performed on a document might not be applied to a document template, so that the user needs to memorize the operations corresponding to a document and a document template respectively, which adds to the memory cost.

In some embodiments of the present disclosure, the displaying a first document comprises: displaying the first document in an open state; and keeping displaying the first document in an open state in response to a first operation event and after the same. In some embodiments, in response to the first operation event, the first document is always in an open state without an operation such as “saved as”, so that the first document is not required to be closed; when a document template attribute is provided to the first document, the entire display page will not affect the display of the first document.

In some embodiments, the document template information is displayed in an associated area of the first document or an associated area of the content page of the first document, wherein the document template information comprises at least one of a creator or the use information. In some embodiments, as shown in FIG. 4, “This template created by @Zhang San has been used for 0 times” is displayed in the first document; in some embodiments, as shown in FIG. 4, a template status bar is displayed below the top of the first document as a bearing area for template-related functions, so that the first control and the document template information are displayed in the template status bar. Since the first control is directly displayed in the first document, when a user intends to create a document by using the first document as a template, a document may be directly created and the user need not to memorize a path to search for a template. In some embodiments, no matter which user opens the first document, the second control and the document template information are both displayed; in some other embodiments, the first control and the document template information are displayed only when the user with a first permission to the first document opens the first document; otherwise, they will not be displayed.

In some embodiments of the present disclosure, the method further comprises: adding the first document into the target folder in response to a fourth operation event on the first document. In some embodiments, the fourth operation event may be, for example, a classification operation on the first document, and the method in this embodiment may be used for document application; the target folder may be any folder in the document application, for example, a shared folder shown in FIG. 5, so that a shared folder may be created by a “Create Shared Folder” control shown in FIG. 5.

In some embodiments of the present disclosure, the method further comprises: adding the first document to a quick access portal in response to a fifth operation event on the first document. In some embodiments, as shown in FIG. 5, the first document may be added to the quick access portal, which may be displayed in a homepage of the document application, so that the user may directly access the first document in the homepage, and the template tag still displayed in an associated area of the title of the first document displayed in the quick access portal may be seen.

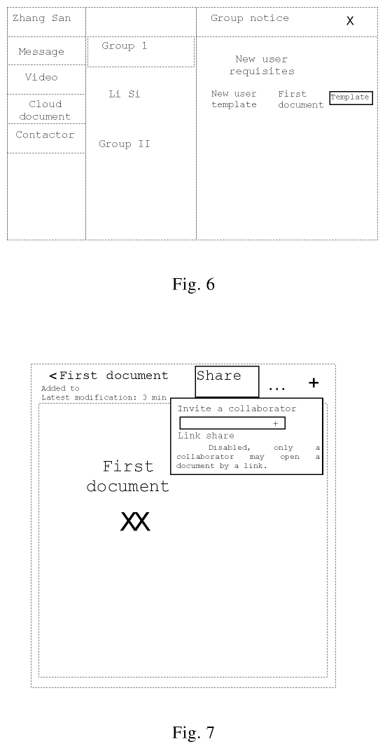

In some embodiments of the present disclosure, the method further comprises: adding the first document to a group notice in response to a sixth operation event on the first document. In some embodiments, the first document may be added to any group of communication applications associated with a target application as a group notice; in the related art, the group notice has to use a document, instead of a document template; in the embodiment of the present disclosure, since the first document is both a document and a document template, the first document may be added to the group notice. As shown in FIG. 6, when the first document is displayed in the group notice, the template tag is also displayed on a peripheral side of the first document (a block with “template” inside as the template tag is displayed on a right side of the “first document” in the group notice on a right side of FIG. 6).

In some embodiments of the present disclosure, the method further comprises: adding the first document to a user name card in response to a seventh operation event on the first document. In some embodiments, the user name card refers to an electric name card of the user, for example, an electronic signature of the user, and a document may be added to the user name card; in this embodiment, since the first document maintains a document attribute, the first document may be added to the user name card.

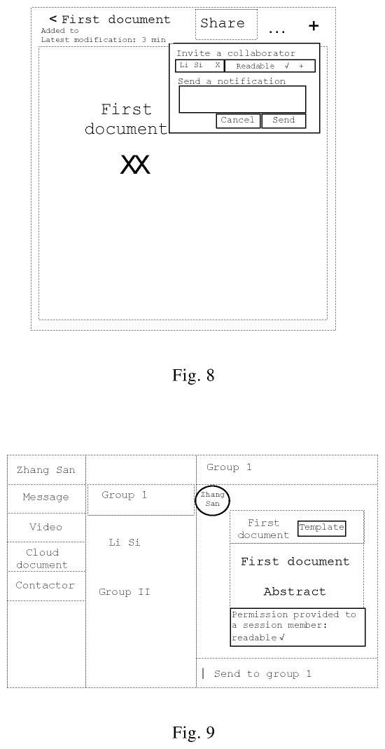

In some embodiments of the present disclosure, the method further comprises: determining a target object and sharing the first document to the target object in response to an eighth operation event on the first document. In some embodiments, referring to FIGS. 7 to 9, a share control (a block with “Share” inside shown on the top area of FIG. 7 is the share control) for sharing may be displayed in or near the first document; by triggering the share control, a sharing interface (a block with “Invite a collaborator” and “Link share” shown inside, below the share control in FIG. 7) may be displayed, so that a collaborator may be invited as a target object in the sharing interface, and a permission may be provided for a target object when sharing, wherein the permission may comprise a reading permission and an editing permission (in FIG. 8, Li Si is invited as a collaborator and provided with a reading permission), and comments may be added when sharing; when sharing, the first document may be shared to a group with a target object, and since a permission is set for a target object, the group members who do not have the permission cannot access the first document by sharing. In the related art, the document template cannot be shared, while in this embodiment, since the first document has a document attribute, the first document as a document template may be shared. In this embodiment, since the document template is also a document at the same time, without the constraints of a template, it is also possible to share and forward the first document like an ordinary document.

In some embodiments of the present disclosure, the method further comprises: creating a third document by using the first document as a template in response to a trigger operation on the first control; and synchronizing the content of the third document to the first document in response to a ninth operation event on the third document. In some embodiments, the third document is a document created with the first document as a document template; after editing the third document, it is possible to have such a circumstance that that the third document is more suitable as a template; in this case, the ninth operation event may be performed on the third document, for example, triggering a third control in the third document, so that the content in the third document is returned to the first document as a document template, and in this way, it is not necessary to perform an operation of converting the third document into a document template or to delete the first document, which is convenient for an operation by the user.

In some embodiments of the present disclosure, an information processing apparatus is provided, the apparatus comprising:
a display unit for displaying a first document; and
a control unit for adding a document template attribute to the first document in response to a first operation event on the first document, and displaying a first control in an associated area of the first document or an associated area of a content page of the first document, wherein the first control is used for creating a document by using the first document as a template after the first control is triggered.

In some embodiments, the control unit adds a document template attribute to the first document in response to a first operation event on a first document, comprising:
adding a document template attribute to the first document in response to a second control associated with the first document shifting from a first state to a second state, wherein the second control has a first state and a second state, so that the first document has a document attribute when the second control is in the first state, and the first document has both a document attribute and a document template attribute when the second control is in the second state.

In some embodiments, the control unit is further configured to add a template tag to the first document, and the template tag is used for identifying the first document as a document template.

In some embodiments, the control unit is further configured to display the template tag in an associated area of the title of the first document, and the template tag is used for identifying the first document as a document template.

In some embodiments, the control unit is further configured to display a second document created by using the first document as a template in response to a second operation event on the first document.

In some embodiments, the control unit is further configured to modify the content in the first document in response to a first modification operation; and apply the modified content of the first document to the second document in response to a third operation event on the first document.

In some embodiments, the control unit is further configured to display the first document in a document classification of the document database and display the first document in a document template classification.

In some embodiments, the control unit is further configured to display the document template information in an associated area of the first document or an associated area of a content page of the first document, wherein the document template information comprises at least one of a creator or the use information.

In some embodiments, the control unit is further configured to at least one of:
add the first document into a target folder in response to a fourth operation event on the first document;
add the first document to a quick access portal in response to a fifth operation event on the first document;
add the first document to a group notice in response to a sixth operation event on the first document;
add the first document to a user name card in response to a seventh operation event on the first document; or
determine a target object and share the first document to the target object in response to an eighth operation event on the first document.

In some embodiments, the control unit is further configured to create a third document by using the first document as a template in response to a trigger operation on the first control; and synchronize the content of the third document to the first document in response to a ninth operation event on the third document.

As for the embodiments of a device, since they substantially correspond to the embodiments of the method, for relevant parts, reference may be made to some descriptions of the embodiments of the method. The embodiments of the device described above are only schematic, wherein the modules described as separate modules may or may not be separate. Some or all of the modules may be selected to achieve the object of the solution in the present embodiment according to actual needs. Those of ordinary skill in the art may understand and implement them in the case where no inventive effort is involved.

The method and device of the present disclosure have been described above based on the embodiments and application examples. In addition, the present disclosure also provides a terminal and a storage medium, which will be described below.

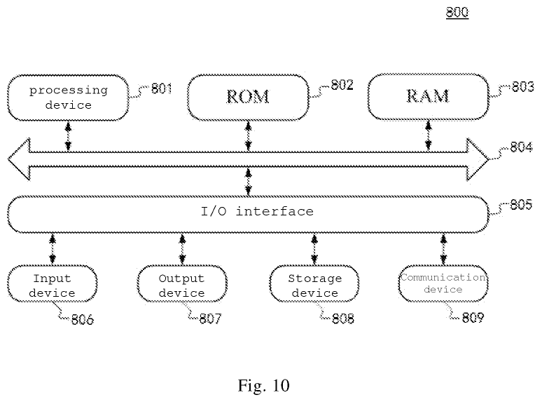

Next, referring to FIG. 10, it shows a structural schematic view of an electronic device 800 (for example, a terminal device or a server) suitable for implementing the embodiment of the present disclosure. The terminal device in an embodiment of the present disclosure may comprise, but is not limited to, mobile terminals such as mobile phones, notebook computers, digital broadcast receivers, PDAs (personal digital assistants), PADs (pad computers), PMPs (Portable Multimedia Players) and in-vehicle terminals (for example, in-vehicle navigation terminals), and fixed terminals such as digital TVs, desktop computers and the like. The electronic device shown in the figure, which is only an example, shall not limit the functions and application range of the embodiments of the present disclosure.

As shown in FIG. 10, the electronic device 800 may comprise a processing device (for example, a central processing unit, a graphic processor, and the like) 801, which may perform various suitable actions and processing according to a program stored in a Read-only Memory (ROM) 802 or a program loaded from a storage device 808 into a Random Access Memory (RAM) 803. In the RAM 803, various programs and data required for the operation of the electronic device 800 are also stored. The processing device 801, the ROM 802 and the RAM 803 are connected to each other through a bus 804. The input/output (I/O) interface 805 is also connected to the bus 804.

Generally, the following devices may be connected to the I/O interface 805: an input device 806 comprising, for example, a touch screen, a touch pad, a keyboard, a mouse, a camera, a microphone, an accelerometer, a gyroscope, and the like; an output device 807 comprising, for example, a Liquid Crystal Display (LCD), a speaker, a vibrator, and the like; a storage device 808 comprising, for example, a magnetic tape, a hard disk, and the like; and a communication device 809. The communication device 809 may allow the electronic device 800 to be in wireless or wired communication with other devices to exchange data. Although the electronic device 800 with various devices is shown in the figure, it should be understood that there is no requirement to implement or have all the devices shown. It is possible to alternatively implement or possess more or less devices.

In particular, according to an embodiment of the present disclosure, the process described above with reference to the flowchart may be implemented as a computer software program. For example, in the embodiment of the present disclosure, a computer program product is comprised, which comprises a computer program carried on a computer-readable medium, wherein the computer program contains program codes for performing the method shown in the flow chart. In such embodiment, the computer program may be downloaded and installed from the network through the communication device 809, or installed from the storage device 808, or installed from the ROM 802. When the computer program is executed by the processing device 801, the above-described functions defined in the method of the embodiment of the present disclosure are performed.

It is to be noted that, the above-described computer-readable medium of the present disclosure may be a computer-readable signal medium, a computer-readable storage medium or any combination thereof. The computer-readable storage medium may be, for example, but is not limited to: an electrical, magnetic, optical, electromagnetic, infrared, or semiconductor system, apparatus, or device, or a combination thereof. More specific examples of the computer-readable storage medium may comprise, but are not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium that contains or stores a program which may be used by an instruction execution system, apparatus, or device or used in combination therewith. In the present disclosure, the computer-readable signal medium may comprise a data signal propagated in a baseband or as a part of a carrier wave, wherein a computer-readable program code is carried. Such propagated data signal may take many forms, comprising but not limited to an electromagnetic signal, an optical signal, or any suitable combination thereof. The computer-readable signal medium may also be any computer-readable medium other than the computer-readable storage medium, wherein the computer-readable signal medium may send, propagate, or transmit a program for use by an instruction execution system, apparatus, or device or in combination with therewith. The program code contained on the computer-readable medium may be transmitted by any suitable medium, comprising but not limited to: a wire, an optical cable, radio frequency (RF), and the like, or any suitable combination thereof.

In some embodiments, the client and the server may communicate using any currently known or future developed network protocol such as HTTP (HyperText Transfer Protocol), and may be interconnected with digital data communication in any form or medium (for example, communication network). Examples of communication networks comprise a Local Area Network (“LAN”), a Wide Area Network (“WAN”), an extranet (for example, Internet) and an end-to-end network (for example, an ad hoc end-to-end network), as well as any currently known or future developed network.

The above-described computer-readable medium may be comprised in the above-described electronic device; or may also exist alone without being assembled into the electronic device.

The above-described computer-readable medium carries one or more programs that, when executed by the electronic device, cause the electronic device to perform the above-described method of the present disclosure.

The computer program code for performing the operations of the present disclosure may be written in one or more programming languages or a combination thereof, wherein the above-described programming languages comprise object-oriented programming languages, such as Java, Smalltalk, and C++, and also comprise conventional procedural programming languages, such as “C” language or similar programming languages. The program code may be executed entirely on the user's computer, partly on the user's computer, executed as an independent software package, partly on the user's computer and partly executed on a remote computer, or entirely executed on the remote computer or server. In a case involving a remote computer, the remote computer may be connected to the user's computer through any kind of network (comprising a local area network (LAN) or a wide area network (WAN)), or may be connected to an external computer (for example, connected through Internet using an Internet service provider).

The flowcharts and block views in the accompanying drawings illustrate the possibly implemented architectures, functions, and operations of the system, method, and computer program product according to various embodiments of the present disclosure. In this regard, each block in the flowchart or block view may represent a module, a program segment, or a part of code, wherein the module, the program segment, or the part of code contains one or more executable instructions for realizing a specified logic function. It should also be noted that, in some alternative implementations, the functions marked in the block may also occur in a different order from the order marked in the accompanying drawings. For example, two blocks shown in succession may actually be executed substantially in parallel, may sometimes also be executed in a reverse order, depending on the functions involved. It should also be noted that each block in the block view and/or flowchart, and a combination of the blocks in the block view and/or flowchart, may be implemented by a dedicated hardware-based system that performs the specified functions or operations, or may be implemented by a combination of dedicated hardware and computer instructions.

The units involved in the described embodiments of the present disclosure may be implemented in software or hardware. Wherein, the names of the units do not constitute a limitation on the units themselves under certain circumstances.

The functions described hereinabove may be performed at least in part by one or more hardware logic components. For example, without limitation, the hardware logic components of a demonstrative type that may be used comprise: a Field Programmable Gate Array (FPGA), an Application Specific Integrated Circuit (ASIC), an Application Specific Standard Product (ASSP), a System on Chip (SOC), a Complex Programmable Logical device (CPLD) and the like.

In the context of the present disclosure, a machine-readable medium may be a tangible medium, which may contain or store a program for use by the instruction execution system, apparatus, or device or use in combination with the instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus or device, or any suitable combination thereof. More specific examples of the machine-readable storage medium may comprise an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, an information processing method is provided, the method comprising:
displaying a first document; and
adding a document template attribute to the first document in response to a first operation event on the first document, and displaying a first control in an associated area of the first document or an associated area of a content page of the first document, wherein the first control is used for creating a document by using the first document as a template after the first control is triggered.

According to one or more embodiments of the present disclosure, an information processing method is provided, wherein the adding a document template attribute to the first document in response to a first operation event on the first document comprises:

adding a document template attribute to the first document in response to a second control associated with the first document shifting from a first state to a second state, wherein the second control has a first state and a second state, so that the first document has a document attribute when the second control is in the first state, and the first document has both the document attribute and the document template attribute when the second control is in the second state.

According to one or more embodiments of the present disclosure, an information processing method is provided, the method further comprising: adding a template tag for the first document, wherein the template tag is used for identifying the first document as a document template.

According to one or more embodiments of the present disclosure, an information processing method is provided, the method comprising:
displaying the template tag in an associated area of the title of the first document, wherein the template tag is used for identifying the first document as a document template.

According to one or more embodiments of the present disclosure, an information processing method is provided, the method further comprises at least one of the following: displaying a second document created by using the first document as a template in response to a second operation event on the first document; or modifying the content in the first document in response to a first modification operation, and applying the modified content of the first document to the second document in response to a third operation event on the first document.

According to one or more embodiments of the present disclosure, an information processing method is provided, the method further comprising:
displaying the first document in a document classification of a document database, and displaying the first document in a document template classification.

According to one or more embodiments of the present disclosure, an information processing method is provided, the method further comprising:
displaying the document template information in an associated area of the first document or an associated area of a content page of the first document, wherein the document template information comprises at least one of a creator or the use information.

According to one or more embodiments of the present disclosure, an information processing method is provided, the method further comprising at least one of the following: adding the first document into a target folder in response to a fourth operation event on the first document;
adding the first document to a quick access portal in response to a fifth operation event on the first document;
adding the first document to a group notice in response to a sixth operation event on the first document;
adding the first document to a user name card in response to a seventh operation event on the first document; or
determining a target object and sharing the first document to the target object in response to an eighth operation event on the first document.

According to one or more embodiments of the present disclosure, an information processing method is provided, the method further comprising:
creating a third document by using the first document as a template in response to a trigger operation on the first control; and
synchronizing the content of the third document to the first document in response to a ninth operation event on the third document.

According to one or more embodiments of the present disclosure, an information processing apparatus is provided, the apparatus comprising:
a display unit for displaying a first document; and
a control unit for adding a document template attribute to the first document in response to a first operation event on the first document, and displaying a first control in an associated area of the first document or an associated area of a content page of the first document, wherein the first control is used for creating a document by using the first document as a template after the first control is triggered.

According to one or more embodiments of the present disclosure, a terminal is provided, the terminal comprising: at least one memory and at least one processor;
wherein the at least one memory is configured to store program codes, and the at least one processor is configured to call the program codes stored in the at least one memory to perform the above-described method described according to any of the embodiments of the present disclosure.

According to one or more embodiments of the present disclosure, a non-transient computer-readable storage medium is provided, wherein the computer-readable storage medium is configured to store program codes that, when executed by a processor, causes the processor to perform the method according to any of the embodiments of the present disclosure.

The above description is only an explanation of preferred embodiments of the present disclosure and the applied technical principles. Those skilled in the art should understand that the scope of disclosure involved in this disclosure is not limited to the technical solutions formed by the specific combination of the above technical features, and at the same time should also cover other technical solutions formed by arbitrarily combining the above-described technical features or equivalent features without departing from the above disclosed concept. For example, a technical solution formed by the above-described features and the technical features having similar functions disclosed in the present disclosure (but not limited thereto) replacing with each other.

In addition, although the operations are depicted in a specific order, this should not be understood as requiring these operations to be performed in the specific order shown or performed in a sequential order. Under certain circumstances, multitasking and parallel processing might be advantageous. Likewise, although several specific implementation details are contained in the above discussion, these should not be construed as limiting the scope of the present disclosure. Certain features that are described in the context of individual embodiments may also be implemented in combination in a single embodiment. On the contrary, various features described in the context of a single embodiment may also be implemented in multiple embodiments individually or in any suitable sub-combination.

Although the present subject matter has been described in language specific to structural features and/or methodological actions, it should be understood that the subject matter defined in the appended claims is not necessarily limited to the specific features or actions described above. On the contrary, the specific features and actions described above are only exemplary forms of implementing the claims.

What is claimed is:

1. An information processing method, characterized in that it comprises:
displaying a first document; and
adding a document template attribute to the first document in response to a first operation event on the first document, and displaying a first control in an associated area of the first document or an associated area of a content page of the first document, wherein the first control is used for creating a document by using the first document as a template after the first control is triggered.

2. The method according to claim 1, characterized in that the adding a document template attribute to the first document in response to a first operation event on the first document comprises:
adding a document template attribute to the first document in response to a second control associated with the first document shifting from a first state to a second state, wherein the second control has the first state and the second state, so that the first document has a document attribute when the second control is in the first state, and the first document has both the document attribute and the document template attribute when the second control is in the second state.

3. The method according to claim 1, characterized in that it further comprises: adding a template tag to the first document, wherein the template tag is used for identifying the first document as a document template.

4. The method according to claim 3, characterized in that it comprises:
displaying the template tag in an associated area of a title of the first document, wherein the template tag is used for identifying the first document as the document template.

5. The method according to claim 1, characterized in that it further comprises at least one of the following:
displaying a second document created by using the first document as a template in response to a second operation event on the first document; or
modifying the content in the first document in response to a first modifying operation; and
applying the modified content of the first document to the second document in response to a third operation event on the first document.

6. The method according to claim 1, characterized in that it further comprises:
displaying the first document in a document classification of a document database, and displaying the first document in a document template classification.

7. The method according to claim 1, characterized in that it further comprises:
displaying the document template information in an associated area of the first document or an associated area of a content page of the first document, wherein the document template information comprises at least one of a creator or the use information.

8. The method according to claim 1, characterized in that it further comprises at least one of the following:
adding the first document into a target folder in response to a fourth operation event on the first document;
adding the first document to a quick access portal in response to a fifth operation event on the first document;
adding the first document to a group notice in response to a sixth operation event on the first document;
adding the first document to a user name card in response to a seventh operation event on the first document; or
determining a target object and sharing the first document to the target object in response to an eighth operation event on the first document.

9. The method according to claim 1, characterized in that it further comprises:
creating a third document by using the first document as a template in response to a trigger operation on the first control; and
synchronizing the content of the third document to the first document in response to a ninth operation event on the third document.

10. A terminal, comprising:
at least one memory and at least one processor;
wherein the at least one memory is configured to store program codes, and the at least one processor is configured to call the program codes stored in the at least one memory to perform an information processing method comprising:
displaying a first document; and
adding a document template attribute to the first document in response to a first operation event on the first document, and displaying a first control in an associated area of the first document or an associated area of a content page of the first document, wherein the first control is used for creating a document by using the first document as a template after the first control is triggered.

11. A non-transient computer-readable storage medium for storing program codes that, when executed by a processor, causes the processor to perform an information processing method comprising:
displaying a first document; and
adding a document template attribute to the first document in response to a first operation event on the first document, and displaying a first control in an associated area of the first document or an associated area of a content page of the first document, wherein the first control is used for creating a document by using the first document as a template after the first control is triggered.

12. The terminal according to claim 10, characterized in that the adding a document template attribute to the first document in response to a first operation event on the first document comprises:
adding a document template attribute to the first document in response to a second control associated with the first document shifting from a first state to a second state, wherein the second control has the first state and the second state, so that the first document has a document attribute when the second control is in the first state, and the first document has both the document attribute and the document template attribute when the second control is in the second state.

13. The terminal according to claim 10, characterized in that it further comprises: adding a template tag to the first document, wherein the template tag is used for identifying the first document as a document template.

14. The terminal according to claim 13, characterized in that it comprises:
displaying the template tag in an associated area of a title of the first document, wherein the template tag is used for identifying the first document as the document template.

15. The terminal according to claim 10, characterized in that it further comprises at least one of the following:
displaying a second document created by using the first document as a template in response to a second operation event on the first document; or
modifying the content in the first document in response to a first modifying operation; and
applying the modified content of the first document to the second document in response to a third operation event on the first document.

16. The terminal according to claim 10, characterized in that it further comprises:
displaying the first document in a document classification of a document database, and displaying the first document in a document template classification.

17. The non-transient computer-readable storage medium according to claim 11, characterized in that the adding a document template attribute to the first document in response to a first operation event on the first document comprises:
adding a document template attribute to the first document in response to a second control associated with the first document shifting from a first state to a second state, wherein the second control has the first state and the second state, so that the first document has a document attribute when the second control is in the first state, and the first document has both the document attribute and the document template attribute when the second control is in the second state.

18. The non-transient computer-readable storage medium according to claim 11, characterized in that it further comprises: adding a template tag to the first document, wherein the template tag is used for identifying the first document as a document template.

19. The non-transient computer-readable storage medium according to claim 18, characterized in that it comprises:
displaying the template tag in an associated area of a title of the first document, wherein the template tag is used for identifying the first document as the document template.

20. The non-transient computer-readable storage medium according to claim 11, characterized in that it further comprises at least one of the following:
displaying a second document created by using the first document as a template in response to a second operation event on the first document; or
modifying the content in the first document in response to a first modifying operation; and
applying the modified content of the first document to the second document in response to a third operation event on the first document.
